(19) United States
(12) Patent Application Publication
(10) Pub. No.: US 2025/0168131 A1
(43) Pub. Date: May 22, 2025

(54) EXPANDER DEVICE CHANNEL SWITCHING FOR A MEMORY DEVICE

(71) Applicant: Micron Technology, Inc., Boise, ID (US)

(72) Inventors: Leonid Minz, Beer Sheva (IL); Luigi Pilolli, L'Aquila (IT); Gyan Prakash, Bangalore (IN)

(21) Appl. No.: 18/952,670

(22) Filed: Nov. 19, 2024

Related U.S. Application Data
(60) Provisional application No. 63/602,042, filed on Nov. 22, 2023.

(51) Int. Cl. H04L 49/45; H04L 49/103; H04L 49/25

(52) U.S. Cl. CPC H04L 49/455; H04L 49/103; H04L 49/256

(57) ABSTRACT

A method includes receiving, by a memory device interface, a signal from a host that includes a header, decoding, by the memory device interface, the header to determine an instruction, selecting, by the memory device interface, a first channel associated with a first memory resource based on the instruction, sending, by the memory device interface, the header to a second channel associated with a second memory resource, and sending, by the memory device interface, subsequent packets of the header to the first channel.

### PRIORITY INFORMATION

This application claims the benefit of U.S. Provisional Application No. 63/602,042, filed on Nov. 22, 2023, the contents of which are incorporated herein by reference.

### TECHNICAL FIELD

Embodiments of the disclosure relate generally to memory sub-systems, and more specifically, relate to expander device channel switching for a memory device

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The present disclosure will be understood more fully from the detailed description given below and from the accompanying drawings of various embodiments of the disclosure.

FIG. 1 illustrates an example computing system that includes a memory sub-system in accordance with some embodiments of the disclosure.

FIG. 2 illustrates a system that includes a multi-channel input/output expander in accordance with some embodiments of the disclosure.

FIG. 3 illustrates timing diagram for expander device channel switching for a memory device in accordance with some embodiments of the disclosure.

FIG. 4 is a flow diagram corresponding to a method for channel switching in accordance with some embodiments of the disclosure.

FIG. 5 is a block diagram of an example computer system in which embodiments of the disclosure may operate.

### DETAILED DESCRIPTION

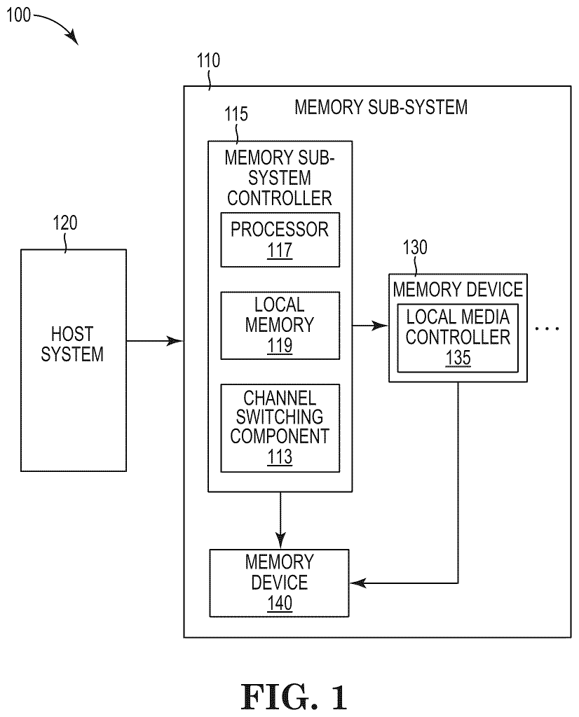

Aspects of the present disclosure are directed to signal locking, in particular to memory sub-systems that include a signal locking component. A memory sub-system can be a storage system, storage device, a memory module, or a combination of such. An example of a memory sub-system is a storage system such as a solid-state drive (SSD). Examples of storage devices and memory modules are described below in conjunction with FIG. 1, et alibi. In general, a host system can utilize a memory sub-system that includes one or more components, such as memory devices that store data. The host system can provide data to be stored at the memory sub-system and can request data to be retrieved from the memory sub-system.

A memory device can be a non-volatile memory device. One example of non-volatile memory devices is a negative-and (NAND) memory device (also known as flash technology). As used herein, a NAND memory device can include either a set of flash memory dice or a combination of the flash memory dice and a non-volatile memory (NVM) controller. The NVM controller can include circuitry for performing read/write operations as described herein. Other examples of non-volatile memory devices are described below in conjunction with FIG. 1. A non-volatile memory device is a package of one or more dice. Each die can consist of one or more planes. Planes can be grouped into logic units (LUN). For some types of non-volatile memory devices (e.g., NAND devices), each plane consists of a set of physical blocks. Each block consists of a set of pages. Each page consists of a set of memory cells (“cells”). A cell is an electronic circuit that stores information. A block hereinafter refers to a unit of the memory device used to store data and can include a group of memory cells, a word line group, a word line, or individual memory cells. For some memory devices, blocks (also hereinafter referred to as “memory blocks”) are the smallest area than can be erased. Pages cannot be erased individually, and only whole blocks can be erased.

Each of the memory devices can include one or more arrays of memory cells. Depending on the cell type, a cell can be written to in order to store one or more bits of binary information, and has various logic states that correlate to the number of bits being stored. The logic states can be represented by binary values, such as “0” and “1”, or combinations of such values. There are various types of cells, such as single-level cells (SLCs), multi-level cells (MLCs), triple level cells (TLCs), and quad-level cells (QLCs). For example, a SLC can store one bit of information and has two logic states.

Some NAND memory devices employ a floating-gate architecture in which memory accesses are controlled based on a relative voltage change between the bit line and the word lines. Other examples of NAND memory devices can employ a replacement-gate architecture that can include the use of word line layouts that can allow for charges corresponding to data values to be trapped within memory cells based on properties of the materials used to construct the word lines.

In some previous approaches, an input/output (IO) expander (IOE) device can be placed between a host and memory dice. For example, an IOE device can be placed between a host device and a plurality of NAND dies (or “LUNs”). The host side of the IOE device can be referred to as a front end (front side) and the memory die side of the IOE device can be referred to as the back-end (back side). The IOE device can allow a host to see a single die load at the IOE device front side (FS). The NAND die loads can be distributed across multiple IOE back side channels. These previous IOE devices can implement a crossbar switch to route the intended traffic to target NAND dies. As used herein, a crossbar switch includes a collection of switches arranged in a matrix configuration. A crossbar switch can have multiple input and output lines that form a crossed pattern of interconnecting lines between which a connection may be established by closing a switch located at each intersection, the elements of the matrix.

In some previous approaches, the IOE device can be implemented with a buffered architecture to allow the crossbar switch to function. In this implementation, all the signals from host to NAND and vice-versa are buffered inside the IOE device and distributed to a desired port of the crossbar switch. In these approaches, the load or load average between the host and the NAND can decrease as a larger quantity of NAND die are added to the system. That is, a previous IOE device will have a lower load capability between the host and the NAND as a greater quantity of NAND dice are added to the system.

In some previous approaches, the IOE device can receive communication at a front end from a host device and provide the communication to a memory resource at a back-end. In these previous approaches the host device can utilize headers (e.g., vendor specific (VSP) headers, etc.) during an SCA mode of operation. In these previous embodiments, the headers can be passed through to the same memory resource as the payload or other parts of the communication. In some previous embodiments, there can be a risk that the headers will cause a malfunction with the memory resource. In some embodiments, it can be difficult or not possible to filter the headers from being provided to the memory resource, which can cause delays or malfunctions related to the host communicating with the memory resource.

Aspects of the present disclosure address the above and other deficiencies by employing an IOE device that utilizes channel switching. For instance, aspects of the present disclosure can utilize a channel switching component that can be configured to switch a channel in response to receiving a header. For example, in some embodiments, the header can include instructions to switch and/or select a back-end channel of the IOE device. In some embodiments, the header can be utilized to select and/or switch the back-end channel for the payload of the communication associated with the header. For example, in a specific embodiment, a communication packet can be sent to the IOE device. The communication packet can include a header that includes instructions to switch the back-end channel from a first back-end channel to a second back-end channel. In this example, the header can be sent to the first back-end channel and the payload or other portions of the communication packet can be sent to the second back-end channel. In this way, the header will not negatively affect the memory resource coupled to the second back-end channel. In this way, the header can be utilized to initiate a back-end channel switch of the IOE device without potentially affecting the performance of the memory resource associated with a memory resource that will be utilized to receive the communication.

FIG. 1 illustrates an example computing system that includes a memory sub-system 110 in accordance with some embodiments of the disclosure. The memory sub-system 110 can include media, such as one or more volatile memory devices (e.g., memory device 140), one or more non-volatile memory devices (e.g., memory device 130), or a combination of such.

A memory sub-system 110 can be a storage device, a memory module, or a hybrid of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory modules (NVDIMMs).

The computing system 100 can be a computing device such as a desktop computer, laptop computer, server, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include a host system 120 that is coupled to one or more memory sub-systems 110. In some embodiments, the host system 120 is coupled to different types of memory sub-system 110. FIG. 1 illustrates one example of a host system 120 coupled to one memory sub-system 110. As used herein, “coupled to” or “coupled with” generally refers to a connection between components, which can be an indirect communicative connection or direct communicative connection (e.g., without intervening components), whether wired or wireless, including connections such as electrical, optical, magnetic, and the like.

The host system 120 can include a processor chipset and a software stack executed by the processor chipset. The processor chipset can include one or more cores, one or more caches, a memory controller (e.g., an SSD controller), and a storage protocol controller (e.g., PCIe controller, SATA controller). The host system 120 uses the memory sub-system 110, for example, to write data to the memory sub-system 110 and read data from the memory sub-system 110.

The host system 120 can be coupled to the memory sub-system 110 via a physical host interface. Examples of a physical host interface include, but are not limited to, a serial advanced technology attachment (SATA) interface, a peripheral component interconnect express (PCIe) interface, universal serial bus (USB) interface, Fibre Channel, Serial Attached SCSI (SAS), Small Computer System Interface (SCSI), a double data rate (DDR) memory bus, a dual in-line memory module (DIMM) interface (e.g., DIMM socket interface that supports Double Data Rate (DDR)), Open NAND Flash Interface (ONFI), Double Data Rate (DDR), Low Power Double Data Rate (LPDDR), or any other interface. The physical host interface can be used to transmit data between the host system 120 and the memory sub-system 110. The host system 120 can further utilize an NVM Express (NVMe) interface to access components (e.g., memory devices 130) when the memory sub-system 110 is coupled with the host system 120 by the PCIe interface. The physical host interface can provide an interface for passing control, address, data, and other signals between the memory sub-system 110 and the host system 120. FIG. 1 illustrates a memory sub-system 110 as an example. In general, the host system 120 can access multiple memory sub-systems via a same communication connection, multiple separate communication connections, and/or a combination of communication connections.

The memory devices 130, 140 can include any combination of the different types of non-volatile memory devices and/or volatile memory devices. The volatile memory devices (e.g., memory device 140) can be, but are not limited to, random access memory (RAM), such as dynamic random access memory (DRAM) and synchronous dynamic random access memory (SDRAM).

Some examples of non-volatile memory devices (e.g., memory device 130) include negative-and (NAND) type flash memory and write-in-place memory, such as three-dimensional cross-point (“3D cross-point”) memory device, which is a cross-point array of non-volatile memory cells. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory devices 130, 140 can include one or more arrays of memory cells. One type of memory cell, for example, single-level cells (SLC) can store one bit per cell. Other types of memory cells, such as multi-level cells (MLCs), triple level cells (TLCs), quad-level cells (QLCs), and penta-level cells (PLC) can store multiple bits per cell. In some embodiments, each of the memory devices 130 can include one or more arrays of memory cells such as SLCs, MLCs, TLCs, QLCs, or any combination of such. In some embodiments, a particular memory device can include an SLC portion, a MLC portion, a TLC portion, a QLC portion, and/or a PLC portion of memory cells. The memory cells of the memory devices 130 can be grouped as pages that can refer to a logical unit of the memory device used to store data. With some types of memory (e.g., NAND), pages can be grouped to form blocks.

Although non-volatile memory components such as three-dimensional cross-point arrays of non-volatile memory cells and NAND type memory (e.g., 2D NAND, 3D NAND) are described, the memory device 130 can be based on any other type of non-volatile memory or storage device, such as such as, read-only memory (ROM), phase change memory (PCM), self-selecting memory, other chalcogenide based memories, ferroelectric transistor random access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), negative-or (NOR) flash memory, and electrically erasable programmable read-only memory (EEPROM).

As described above, the memory components can be memory dice or memory packages that form at least a portion of the memory device 130. In some embodiments, the blocks of memory cells can form one or more “superblocks.” As used herein, a “superblock” generally refers to a set of data blocks that span multiple memory dice and are written in an interleaved fashion. For instance, in some embodiments each of a number of interleaved NAND blocks can be deployed across multiple memory dice that have multiple planes and/or pages associated therewith. The terms “superblock,” “block,” “block of memory cells,” and/or “interleaved NAND blocks,” as well as variants thereof, can, given the context of the disclosure, be used interchangeably.

The memory sub-system controller 115 (or controller 115 for simplicity) can communicate with the memory devices 130 to perform operations such as reading data, writing data, or erasing data at the memory devices 130 and other such operations. The memory sub-system controller 115 can include hardware such as one or more integrated circuits and/or discrete components, a buffer memory, or a combination thereof. The hardware can include digital circuitry with dedicated (i.e., hard-coded) logic to perform the operations described herein. The memory sub-system controller 115 can be a microcontroller, special purpose logic circuitry (e.g., a field programmable gate array (FPGA), an application specific integrated circuit (ASIC), etc.), or other suitable processor.

The memory sub-system controller 115 can be a processor 117 (e.g., a processing device) configured to execute instructions stored in a local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120.

In some embodiments, the local memory 119 can include memory registers storing memory pointers, fetched data, etc. The local memory 119 can also include read-only memory (ROM) for storing micro-code. While the example memory sub-system 110 in FIG. 1 has been illustrated as including the memory sub-system controller 115, in another embodiment of the present disclosure, a memory sub-system 110 does not include a memory sub-system controller 115, and can instead rely upon external control (e.g., provided by an external host, or by a processor or controller separate from the memory sub-system).

In general, the memory sub-system controller 115 can receive commands or operations from the host system 120 and can convert the commands or operations into instructions or appropriate commands to achieve the desired access to the memory device 130 and/or the memory device 140. The memory sub-system controller 115 can be responsible for other operations such as wear leveling operations, garbage collection operations, error detection and error-correcting code (ECC) operations, encryption operations, caching operations, and address translations between a logical address (e.g., logical block address (LBA), namespace) and a physical address (e.g., physical block address, physical media locations, etc.) that are associated with the memory devices 130. The memory sub-system controller 115 can further include host interface circuitry to communicate with the host system 120 via the physical host interface. The host interface circuitry can convert the commands received from the host system into command instructions to access the memory device 130 and/or the memory device 140 as well as convert responses associated with the memory device 130 and/or the memory device 140 into information for the host system 120.

In some embodiments, the memory sub-system 110 can include a cache or buffer (e.g., DRAM) and address circuitry (e.g., a row decoder and a column decoder) that can receive an address from the memory sub-system controller 115 and decode the address to access the memory device 130 and/or the memory device 140. For instance, in some embodiments, the memory device 140 can be a DRAM and/or SRAM configured to operate as a cache for the memory device 130. In such instances, the memory device 130 can be a NAND.

In some embodiments, the memory device 130 includes local media controllers 135 that operate in conjunction with memory sub-system controller 115 to execute operations on one or more memory cells of the memory devices 130. An external controller (e.g., memory sub-system controller 115) can externally manage the memory device 130 (e.g., perform media management operations on the memory device 130). In some embodiments, a memory device 130 is a managed memory device, which is a raw memory device combined with a local controller (e.g., local media controller 135) for media management within the same memory device package. An example of a managed memory device is a managed NAND (MNAND) device. The memory sub-system 110 can also include additional circuitry or components that are not illustrated.

The memory sub-system 110 can include a channel switching component 113, which may be referred to in the alternative as a “controller,” herein. Although not shown in FIG. 1 so as to not obfuscate the drawings, the channel switching component 113 can include various circuitry to facilitate aspects of media management, as detailed herein. In some embodiments, the channel switching component 113 can include special purpose circuitry in the form of an ASIC, FPGA, state machine, and/or other logic circuitry that can allow the channel switching component 113 to orchestrate and/or perform the operations described herein.

In some embodiments, the memory sub-system controller 115 includes at least a portion of the channel switching component 113. For example, the memory sub-system controller 115 can include a processor 117 (processing device) configured to execute instructions stored in local memory 119 for performing the operations described herein. In some embodiments, the channel switching component 113 is part of the memory sub-system 110, an application, or an operating system.

In a non-limiting example, an apparatus (e.g., the computing system 100) can include a channel switching component 113. The channel switching component 113 can be resident on the memory sub-system 110. As used herein, the term “resident on” refers to something that is physically located on a particular component. For example, the channel switching component 113 being “resident on” the memory sub-system 110 refers to a condition in which the hardware circuitry that comprises the channel switching component 113 is physically located on the memory sub-system 110. The term “resident on” can be used interchangeably with other terms such as “deployed on” or “located on,” herein.

As described further herein, the computing system 100 can include an IOE device that can be utilized to connect a host (e.g., host system 120, etc.) to a memory device (e.g., memory device 130, etc.). In some embodiments, the IOE device can be coupled to the host at a front end and coupled to a memory device at a back-end. The host can configure the IOE device based on properties of the memory device. For example, the configuration signals from the host can be received at a chip enable pin of the IOE device. In previous approaches, the configuration signals can be provided to the memory device even though the configuration signals are not intended to be received by the memory device. As described herein, the configuration signals can be detrimental to the performance of the memory device. In some embodiments, the channel switching component 113 can be utilized to filter or prevent the headers from being provided to a particular memory device or to a particular channel.

The channel switching component 113 can be configured to identify a first header associated with a first signal received at the memory device interface. As used herein, a memory device interface can be an IOE device that can communicatively couple a host device or host system 120 to a plurality of memory dice. In some embodiments, the first header is received from a host controller and/or a host system 120. In some embodiments, the first header is a first vendor specific (VSP) header. In some embodiments, the host controller can utilize a first VSP header as a first instruction and a second VSP header as a second instruction that is different than the first instruction. In this way, the host controller can initiate a back-end channel switch of the IOE device utilizing VSP headers.

In these embodiments, the host controller or host system 120 can utilize the first header as a command or instruction for the memory device interface and/or IOE device. For example, the first header can be decoded by the IOE device. Decoding the first header can include analyzing the header to determine an instruction encoded within the first header. In some embodiments, the first header can be associated with a plurality of data packets. In these embodiments, the first header can include instructions to provide the plurality of data packets to a particular back-end channel and/or to a particular memory resource.

In some embodiments, the channel switching component 113 can be configured to allow the first header to pass through a first channel to a first memory resource. In some embodiments, the channel switching component 113 can send or direct the first header to pass through the first channel to a first memory resource coupled to the first channel. As described herein, the first channel can be a back-end channel of the IOE device. In these embodiments, the first channel can be a currently selected channel and the first header can include instructions to switch the channel to a different channel than the selected channel. In this way, the first header can be sent to the first channel prior to switching from the first channel to a second channel and sending communication packets to the second channel.

In some embodiments, the channel switching component 113 can be configured to decode the first header to determine instructions to switch from the first channel to the second channel. As described herein, the first header can be a VSP header that is encoded with instructions to an IOE device for back-end channel switching. For example, the first header can be encoded with instructions for a back-end channel selection. In this example, the IOE device can decode the first header to determine the instructions. In this way, the channel switching component 113 of the host device can instruct the IOE device to switch a back-end channel utilizing a VSP header.

The channel switching component 113 can be configured to switch from the first channel to a second channel associated with a second memory resource in response to allowing the first header to pass through the first channel. As described herein, the first channel can be a first back-end channel of the IOE device. In this way, the second channel can be a second back-end channel of the IOE device that is different than the first channel.

In some embodiments, the channel switching component 113 can execute the switching from the first channel to the second channel in response to the decoded instruction from the first header. In some embodiments, the first channel is a currently selected channel for the IOE device and the second channel is an unselected channel of the IOE device. As described further herein, the first header can be transmitted to the first channel prior to switching from the first channel to the second channel. In this way, the first header is sent to a different back-end channel than the signals or packets (e.g., SCA packets, etc.) that make up the rest of the communication session. In this way, the first header will not interrupt or alter a function of a memory resource to receive the signals and/or packets of the communication session.

The channel switching component 113 can be configured to allow a plurality of packets associated with the first header to pass through the second channel to the second memory resource. As described herein, the IOE device can send the first header to the first channel to a first memory resource and send the plurality of packets associated with the first header to a second back-end channel. In some embodiments, the plurality of packets include simple content access (SCA) packets. In this way, the first header will not affect a performance of the second memory resource receiving the plurality of SCA packets or other signals associated with the first header.

The channel switching component 113 can be configured to identify a second header associated with a second signal. In some embodiments, the second header is received from the host controller. In some embodiments, the second header can be decoded by the channel switching component 113. The second header can be encoded with instructions to switch from the second channel back to the first channel. In some embodiments, the second header can be encoded with instructions to switch from the second channel to a different back-end channel when the IOE device includes additional channels to the first channel and the second channel. In this way, the second header can include the same or similar instructions as the first header.

The channel switching component 113 can be configured to switch from the second channel to the first channel in response to identifying the second header. As described herein, the second header can include similar instructions as the first header. When the channel switching component 113 decodes the second header, the channel switching component 113 can switch the back-end channel to a different channel than the second channel. As described further herein, the channel switching component 113 can send the second header to the second channel and send the packets and/or other signals associated with the second header to a different back-end channel such as, but not limited to, the first channel.

In some embodiments, the channel switching component 113 can be configured to allow the second header to pass through the second channel to the second memory resource. In some embodiments, the first header is a first vendor specific header and the second header is a second vendor specific header. In some embodiments, the first header and the second header are unrecognizable to the plurality of memory dice. As described herein, the first header and the second header may not be recognizable to the plurality of memory dice such that the memory dice can ignore the first header and/or the second header.

However, in some embodiments, the first header and/or the second header may cause a malfunction or create an altered performance of the plurality of memory dice. For this reason, the first header and/or second header can be sent to different back-end channels than the plurality of packets such that the plurality of packets are sent to a different memory resource than the corresponding header to avoid any malfunction or altered performance of the memory resource that is receiving the plurality of packets.

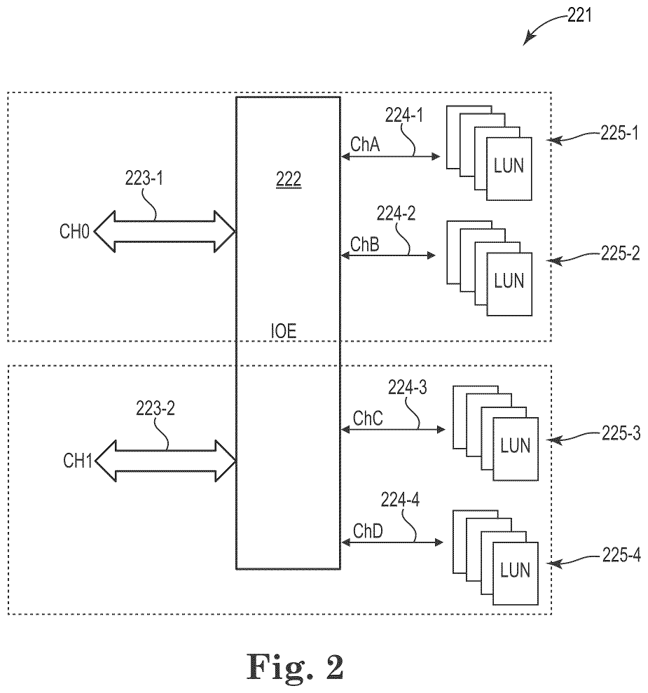

FIG. 2 illustrates a system 221 that includes a multi-channel input/output expander device 222 in accordance with some embodiments of the disclosure. The IOE device 222 can include a device that utilizes a first input channel 223-1 and a second input channel 223-2 that can be connected to a host device or host system. In some embodiments, the IOE device 222 can operate in a one channel mode and/or a two channel mode. In these embodiments, the IOE device 222 can utilize only the first input channel 223-1 in the one channel mode and utilize both the first input channel 223-1 and the second input channel 223-2 in the two channel mode. In some embodiments, the second input channel 223-2 is disabled to execute a one channel mode utilizing the first input channel 223-1.

In some embodiments, the IOE device 222 can include a first plurality of output channels 224-1, 224-2 and a second plurality of output channels 224-3, 224-4. In some embodiments, a first output channel 224-1 can be coupled to a first portion of LUNs 225-1, a second output channel 224-2 can be coupled to a second portion of LUNs 225-2, a third output channel 224-3 can be coupled to a third portion of LUNs 225-3, and a fourth output channel 224-4 can be coupled to a fourth portion of LUNs 225-4. In a one channel mode, the first input channel 223-1 can be utilized to access the plurality of LUNs 225-1, 225-2, 225-3, 225-4. In a two channel mode, the first input channel 223-1 can be utilized to access the first portion of LUNs 225-1 and the second portion of LUNs 225-2 through the first plurality of output channels 224-1, 224-2 and the second input channel 223-2 can be utilized to access the third portion of LUNs 225-3 and the fourth portion of LUNs 225-4 through the second plurality of output channels 224-3, 224-4.

In some previous approaches, a host can provide signals to the IOE device 222 through one of the first input channel 223-1 and the second input channel 223-2. In these previous approaches, signals intended for the IOE device 222 can be transferred to one or more of the plurality of LUNs 225-1, 225-2, 225-3, 225-4. As described further herein, the signals intended for the IOE device 222 can cause unexpected or unintended alterations of the plurality of LUNs 225-1, 225-2, 225-3, 225-4. The present disclosure can utilize an IOE device 222 that includes a signal locking component (e.g., channel switching component 113 as referenced in FIG. 1, etc.).

The channel switching component can be configured to receive a first signal from the host that includes a first header. In some embodiments, the host can provide the first signal to one of the first front end channel 223-1 or the second front end channel 223-2 of the IOE device 222. In some embodiments, the first signal can include a first header that is a VSP header that is encoded with instructions from one of the plurality of back-end channels 224-1, 224-2, 224-3, 224-4 to a different one of the plurality of back-end channels 224-1, 224-2, 224-3, 224-4. The channel switching component can be configured to decode the first header to determine an instruction to switch from the first channel to the second channel.

The channel switching component can be configured to allow the first header to pass through a first channel of the memory device interface to a first memory resource of the non-volatile memory device. As described herein, the first channel can be a first back-end channel of the plurality of back-end channels 224-1, 224-2, 224-3, 224-4. For example, the first channel can be back-end channel 224-1. In this example, the first header can be sent or directed to the LUN 225-1.

The channel switching component can be configured to switch from the first channel to a second channel in response to the first header passing through the first channel. As described herein, the channel switching component can direct the first header through the first channel and then switch the back-end channel of the IOE device 222 from the first channel to the second channel. In a specific example, the channel switching component can be configured to allow the first header to pass through the back-end channel 224-1 and then switch from the back-end channel 224-1 to the back-end channel 224-2. In this way, if the first header alters a performance of the LUN 225-1 it will not affect packets provided to the LUN 225-2 through the back-end channel 224-2.

The channel switching component can be configured to assert the second channel and de-assert the first channel when switching from the first channel to the second channel. In some embodiments, the IOE device 222 can execute an instruction or signal to assert the second channel and de-assert the first channel. In this way, the second channel can be activated and the first channel can be deactivated.

The channel switching component can be configured to receive a plurality of simple content access (SCA) packets from the host. As described herein, the first header can be associated with a plurality of SCA packets. For example, the first header can be followed by the plurality of SCA packets to be provided to one of the plurality of LUNs 225-1, 225-2, 225-3, 225-4. In a specific example, the first header can be provided to the back-end channel 224-1 and the plurality of SCA packets can be provided to the back-end channel 224-2 and provided to the LUN 225-2.

The channel switching component can be configured to allow the plurality of SCA packets to pass through the second channel of the memory device interface to a second memory resource of the non-volatile memory device. As described herein, the plurality of SCA packets can be provided through the back-end channel 224-2 to the LUN 225-2. In this way, the first header is provided to the LUN 225-1 and the plurality of SCA packets are provided to the LUN 225-2.

The channel switching component can be configured to receive a second signal that includes a second header. In some embodiments, the second header can be a second VSP header that is different from the first header. In some embodiments, the second header can be decoded to determine instructions for switching the back-end channel of the IOE device 222. The channel switching component can be configured to allow the second header to pass through the second channel of the memory device interface to the second memory resource of the non-volatile memory device.

The channel switching component can be configured to switch from the second channel to the first channel in response to the second header passing through the second channel. In some embodiments, the channel switching component can decode the second header to determine that the IOE device 222 is to switch from the second channel to a different channel. For example, the second header can include encoded instructions that can be decoded by the channel switching component to switch from the back-end channel 224-2 to the back-end channel 224-1. In this way, a plurality of packets associated with the second header will be provided to a different back-end channel than the second header. In this way, any performance alterations caused by the second header can be avoided when providing the plurality of packets associated with the second header to a memory resource.

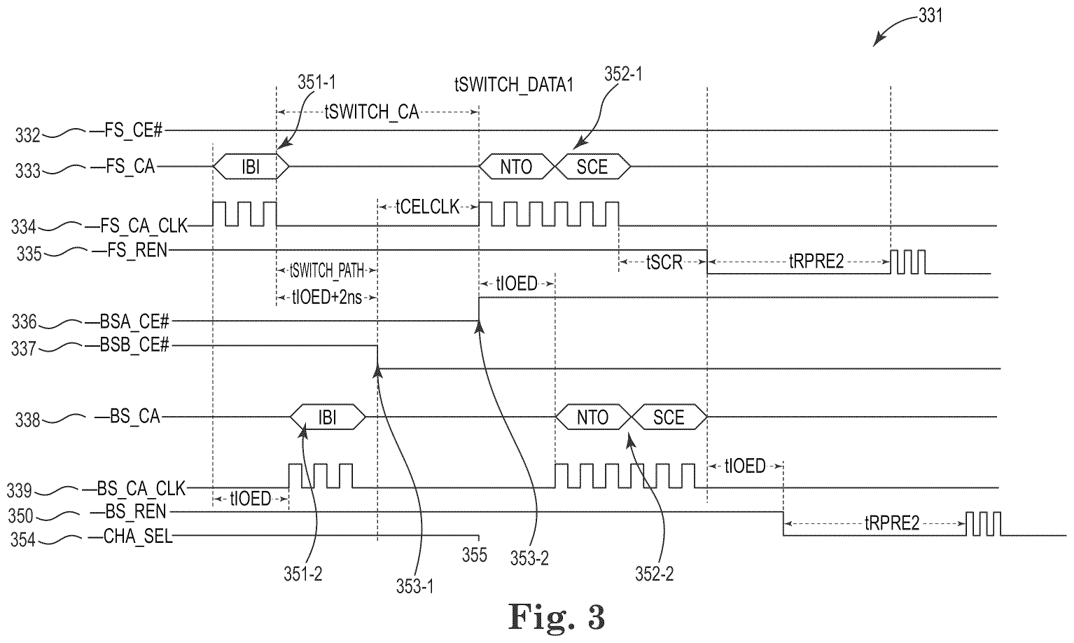

FIG. 3 illustrates timing diagram 331 for channel switching in accordance with some embodiments of the disclosure. In some embodiments, the timing diagram 331 can represent how a plurality of front end signals 332, 333, 334, 335 correspond to a plurality of back-end signals 336, 337, 338, 339, 350. That is, the plurality of front end signals 332, 333, 334, 335 can be signals received from a host at a plurality of corresponding signal pins of an IOE device. The timing diagram 331 can illustrate how the IOE device transmits the plurality of front end signals 332, 333, 334, 335 from the host to a plurality of back-end signals 336, 337, 338, 339, 350 that are provided to memory resources. In addition, the timing diagram 331 includes a channel selection signal 354.

In some embodiments, the plurality of front end signals 332, 333, 334, 335 can include a front end chip enable signal 332, a front end (data) command signal 333, a front end command clock signal 334, and/or a front end read enable signal 335. In a similar way, the plurality of back-end signals 336, 337, 338, 339, 350 can include signals that correspond to the plurality of front end signals 332, 333, 334, 335. For example, the plurality of back-end signals 336, 337, 338 339 can include a back-end chip enable (A) signal 336, a back-end chip enable (B) signal 337, a back-end command signal 338, a back-end clock signal 339, and/or a back-end read enable signal 350.

As described herein, the IOE device can receive a header signal 351-1 on the front end command signal 333. The header signal 351-1 can be a VSP header associated with a plurality of data packets 352-1 that are subsequently received on the front end command signal 333. In these embodiments, the front end clock signal 334 can include corresponding clock signals of the header signal 351-1 and the plurality of data packets 352-1. As described herein, the header signal 351-1 can be utilized to initiate a switch from a first back-end channel (e.g., Channel A, etc.) to a second back-end channel (e.g., Channel B, etc.).

In some embodiments, the timing diagram 331 can include a back-end chip enable (A) signal 336 and a back-end chip enable signal (B) 337. In these embodiments, the back-end chip enable (A) signal 336 can be utilized to assert or de-assert a first back-end channel referred to as back-end channel (A). In a similar way, the back-end chip enable signal (B) 337 can be utilized to assert and/or de-assert a second back-end channel referred to as back-end channel (B). Although two back-end channels are referenced in the timing diagram 331, additional back-end channels can be utilized without departing from the present disclosure.

In some embodiments, the back-end command signal 338 can receive the header 351-2 provided to the front end command signal 333. In some embodiments, the header 351-2 can be provided to a back-end channel (B). In these embodiments, the back-end chip enable signal (B) 337 can receive a de-assert signal 353-1 to de-assert the back-end channel (B). In these embodiments, the back-end chip enable signal (A) 336 can receive an assert signal 353-2 to assert the back-end channel (A). In this way, the timing diagram 331 illustrates the switching from back-end channel (B) to back-end channel (A) after receiving the header 351-2.

In these embodiments, the plurality of packets 352-2 can be received at the back-end command signal 338 and be provided to the back-end channel (A) that is asserted. As described herein, switching the back end channel after receiving the header 351-2 can ensure that the header 351-2 is provided to a different memory resource than the plurality of packets 352-2. In some embodiments, the header 351-2 includes the de-assert signal 353-1 and/or the assert signal 353-2 to initiate the switch from the back-end channel (B) to the back-end channel (A). Furthermore, the channel selection signal 354 can illustrate the channel switch 355 or when the back-end channel is switched from the back-end channel (B) to the back-end channel (A).

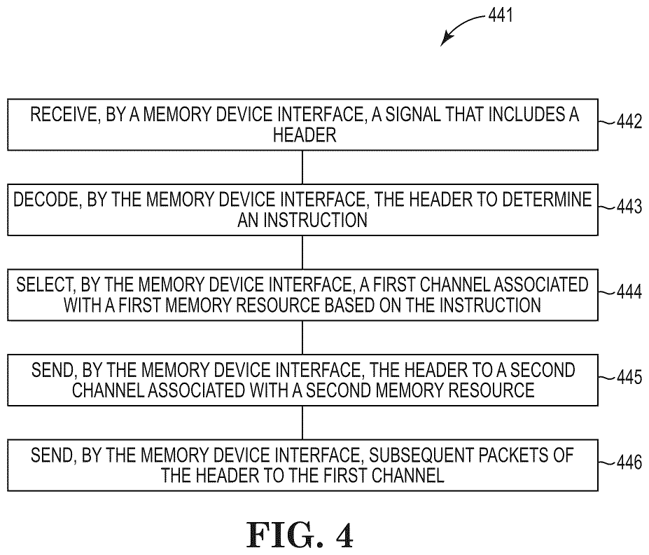

FIG. 4 is a flow diagram corresponding to a method 441 for channel switching in accordance with some embodiments of the disclosure. The method 441 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 441 is performed by the channel switching component 113 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 442, the method 441 can be executed to receive, by a memory device interface, a signal that includes a header. As described herein, the memory device interface can be an IOE device (e.g., IOE device 222 as referenced in FIG. 2, etc.). For example, the memory device interface can include one or more front end channels (e.g., input channels, etc.) and a plurality of back-end channels (e.g., output channels, etc.). In some embodiments, the one or more front end channels can be coupled to a host device and the plurality of back-end channels can be coupled to corresponding memory resources. In this way, a host device can send a signal to the memory device interface to be transmitted to a particular memory device utilizing one of the plurality of back-end channels.

At operation 443, the method 441 can be executed to decode, by the memory device interface, the header to determine an instruction. As described herein, the memory device interface can decode a header associated with the signal to determine the instruction. In some embodiments, a header of a communication session can be encoded with an instruction that designates a particular back-end channel and/or a particular memory resource associated with a particular back-end channel. In this way, the header of the communication can be utilized by the host device to send instructions to the memory device interface. As described herein, the header can be a VSP header that can be utilized by the host to encode instructions that can be decoded by the memory device interface.

At operation 444, the method 441 can be executed to select, by the memory device interface, a first channel associated with a first memory resource based on the instruction. As described herein, the memory device interface can utilize the instruction to select a particular channel (e.g., back-end channel, etc.) for providing signals associated with the communication session. In some embodiments, the first channel that is selected by the memory device interface is a different than a currently selected channel of the memory device interface. In this way, the selected channel is a channel that forces the memory device interface to switch from a particular back-end channel to a different back-end channel.

At operation 445, the method 441 can be executed to send, by the memory device interface, the header to a second channel associated with a second memory resource. In some embodiments, the second channel is a previously selected channel by the memory device interface. For example, the second channel can be a currently selected channel when the signal is received such that the header can be directed to the currently selected channel prior to switching to the channel instructed to be selected by the header. That is, the second channel was a selected channel of the memory device interface upon receiving the signal from the host.

In some embodiments, the method 441 can be executed to send the header to the second channel prior to switching from the second channel to the first channel. As described herein, the header can be sent to the second channel while data packets associated with the header are sent to the first channel. In some embodiments, the method 441 can be executed to maintain, by the second memory resource, a low power mode upon receiving the header from the second channel. In some embodiments, the header may not be recognized by the second memory resource. In these embodiments, the header may not alter or affect the power state of the second memory resource. In this way, when the second memory resource is in a low power state, the header may not alter the power state out of the low power state.

In some embodiments, the method 441 can be executed to ignore, by the second memory resource, the header upon receiving the header from the second channel. As described herein, the header can be a VSP header that is ignored by the second memory resource such that the header does not affect or alter a state of the second memory resource. In addition, the second memory resource is not receiving data packets associated with the header since the data packets are being provided to the first memory resource associated with the first channel.

At operation 446, the method 441 can be executed to send, by the memory device interface, subsequent packets of the header to the first channel. In some embodiments, the method 441 can be executed to send the subsequent packets of the header to the first channel in response to switching from the second channel to the first channel. As described herein, the subsequent packets can be data packets, such as, but not limited to SCA packets. The subsequent packets to the header can be data packets associated with the header. In this way, the host device can instruct the memory device interface on where to direct the subsequent packets utilizing the header. Furthermore, the performance of directing the packets will not be affected by the header or the instruction associated with the header since the header is provided to the second memory resource and the subsequent packets are provided to the first memory resource.

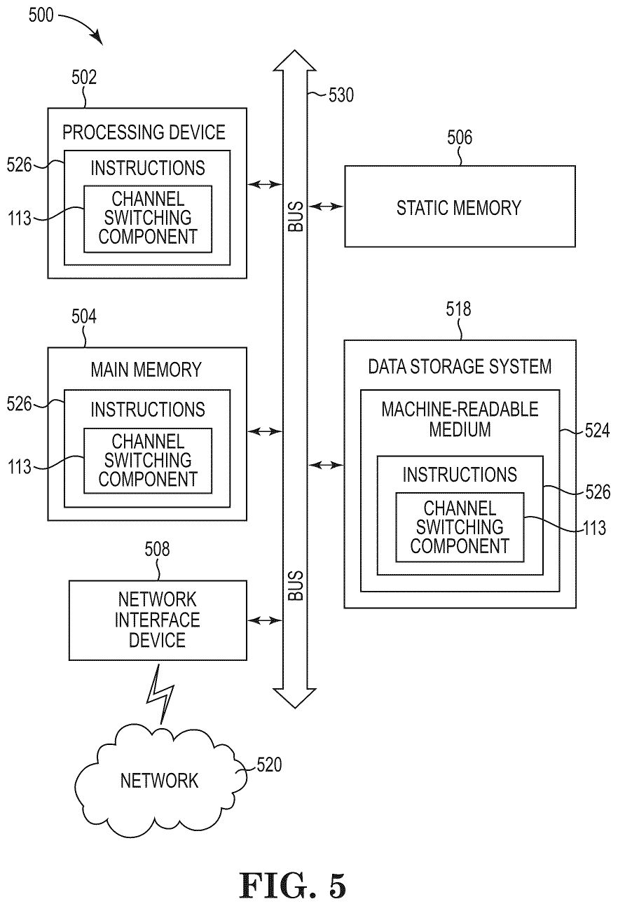

FIG. 5 is a block diagram of an example computer system 500 in which embodiments of the disclosure may operate. For example, FIG. 5 illustrates an example machine of a computer system 500 within which a set of instructions, for causing the machine to perform any one or more of the methodologies discussed herein, can be executed. In some embodiments, the computer system 500 can correspond to a host system (e.g., the host system 120 of FIG. 1) that includes, is coupled to, or utilizes a memory sub-system (e.g., the memory sub-system 110 of FIG. 1) or can be used to perform the operations of a controller (e.g., to execute an operating system to perform operations corresponding to the channel switching component 113 of FIG. 1). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 500 includes a processing device 502, a main memory 504 (e.g., read-only memory (ROM), flash memory, dynamic random access memory (DRAM) such as synchronous DRAM (SDRAM) or Rambus DRAM (RDRAM), etc.), a static memory 506 (e.g., flash memory, static random access memory (SRAM), etc.), and a data storage system 518, which communicate with each other via a bus 530.

The processing device 502 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. The processing device 502 can also be one or more special-purpose processing devices such as an application specific integrated circuit (ASIC), a field programmable gate array (FPGA), a digital signal processor (DSP), network processor, or the like. The processing device 502 is configured to execute instructions 526 for performing the operations and steps discussed herein. The computer system 500 can further include a network interface device 508 to communicate over the network 520.

The data storage system 518 can include a machine-readable storage medium 524 (also known as a computer-readable medium) on which is stored one or more sets of instructions 526 or software embodying any one or more of the methodologies or functions described herein. The instructions 526 can also reside, completely or at least partially, within the main memory 504 and/or within the processing device 502 during execution thereof by the computer system 500, the main memory 504 and the processing device 502 also constituting machine-readable storage media. The machine-readable storage medium 524, data storage system 518, and/or main memory 504 can correspond to the memory sub-system 110 of FIG. 1.

In one embodiment, the instructions 526 include instructions to implement functionality corresponding to a channel switching component (e.g., the channel switching component 113 of FIG. 1). While the machine-readable storage medium 524 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer).

In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc. In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A method, comprising:
receiving, by a memory device interface, a signal that includes a header;
decoding, by the memory device interface, the header to determine an instruction;
selecting, by the memory device interface, a first channel associated with a first memory resource based on the instruction;
sending, by the memory device interface, the header to a second channel associated with a second memory resource; and
sending, by the memory device interface, subsequent packets of the header to the first channel.

2. The method of claim 1, wherein the second channel is a previously selected channel by the memory device interface.

3. The method of claim 1, wherein the second channel was a selected channel of the memory device interface upon receiving the signal from the host.

4. The method of claim 3, further comprising sending the header to the second channel prior to switching from the second channel to the first channel.

5. The method of claim 4, further comprising sending the subsequent packets of the header to the first channel in response to switching from the second channel to the first channel.

6. The method of claim 1, further comprising ignoring, by the second memory resource, the header upon receiving the header from the second channel.

7. The method of claim 1, further comprising maintaining, by the second memory resource, a low power mode upon receiving the header from the second channel.

8. An apparatus, comprising:
a plurality of memory dice; and
a memory device interface to transfer communication between a host couplable to the memory device interface and the plurality of memory dice, wherein the memory device interface comprises a controller configured to:
identify a first header associated with a first signal received at the memory device interface;
allow the first header to pass through a first channel to a first memory resource;
switch from the first channel to a second channel associated with a second memory resource in response to allowing the first header to pass through the first channel;
allow a plurality of packets associated with the first header to pass through the second channel to the second memory resource;
identify a second header associated with a second signal; and
switch from the second channel to the first channel in response to identifying the second header.

9. The apparatus of claim 8, further comprising the controller configured to allow the second header to pass through the second channel to the second memory resource.

10. The apparatus of claim 8, further comprising the controller configured to decode the first header to determine instructions to switch from the first channel to the second channel.

11. The apparatus of claim 8, wherein the plurality of packets include simple content access (SCA) packets.

12. The apparatus of claim 8, wherein the first header is a first vendor specific header and the second header is a second vendor specific header.

13. The apparatus of claim 8, wherein the first header and the second header are received from a host controller.

14. The apparatus of claim 8, wherein the first header and the second header are unrecognizable to the plurality of memory dice.

15. A system comprising:
a memory sub-system comprising a non-volatile memory device; and
a host couplable to the memory sub-system by a memory device interface, the memory device interface comprising a processing device configured to:
receive a first signal from the host that includes a first header;
allow the first header to pass through a first channel of the memory device interface to a first memory resource of the non-volatile memory device;
switch from the first channel to a second channel in response to the first header passing through the first channel;
receive a plurality of simple content access (SCA) packets from the host;
allow the plurality of SCA packets to pass through the second channel of the memory device interface to a second memory resource of the non-volatile memory device;
receive a second signal that includes a second header;
allow the second header to pass through the second channel of the memory device interface to the second memory resource of the non-volatile memory device; and
switch from the second channel to the first channel in response to the second header passing through the second channel.

16. The system of claim 15, wherein the first header and the second header are ignored by the non-volatile memory device.

17. The system of claim 15, wherein the first channel and the second channel are back-end channels of the memory device interface.

18. The system of claim 15, wherein the processing device is further configured to decode the first header to determine an instruction to switch from the first channel to the second channel.

19. The system of claim 18, wherein the instruction identifies that the header is to be provided to the first channel and the plurality of SCA packets are to be provided to the second channel.

20. The system of claim 15, wherein the processing device is further configured to assert the second channel and de-assert the first channel when switching from the first channel to the second channel.
